(19) United States
(12) Patent Application Publication
(10) Pub. No.: US 2021/0148170 A1
(43) Pub. Date: May 20, 2021

(54) In-Wall Ladder for Swimming Pool

(71) Applicant: Hydra Pools, Inc., Sweetwater, TN (US)

(72) Inventor: Laurence A. Nelson, Knoxville, TN (US)

(21) Appl. No.: 16/952,651

(22) Filed: Nov. 19, 2020

Related U.S. Application Data
(60) Provisional application No. 62/938,063, filed on Nov. 20, 2019.

(51) Int. Cl. E06C 9/02; E04H 4/14; E06C 7/18

(52) U.S. Cl. CPC E06C 9/02; E06C 7/181; E04H 4/144

(57) ABSTRACT

An in-wall ladder to be installed in a swimming pool, and a method of constructing the ladder, the ladder including a frame portion configured with a substantially flat front surface and a central opening, a plurality of step portions configured to extend back from the front surface of the frame portion, in a substantially parallel arrangement in the central opening, and a plurality of riser portions configured to extend back in the central opening at an angle from the front surface of the frame portion to a point proximate a back edge of each respective step portion located below each respective riser portion.

### CROSS-REFERENCE TO RELATED APPLICATIONS

This application claims the benefit of U.S. Provisional Patent Application Ser. No. 62/938,063, filed on Nov. 20, 2019, which is incorporated herein in its entirety by reference.

### FIELD OF INVENTION

The present general inventive concept relates to swimming pool ladders, and, more particularly, to a modular in-wall ladder to be installed under a swimming pool liner.

### BACKGROUND

Conventional pool ladders are typically added after the pool liner has been installed. For such an installation, attachment openings have to be made in the liner to accommodate the installation hardware, and such a procedure creates the potential for leaks, further tearing, etc. Even in-wall ladders used in the past were typically made as a thermoformed or fiberglass part which required specific tooling for each configuration. Thus, it would be desirable to have an in-wall ladder that could be produced in any configuration without dedicated tooling, and that could be easily used with other modular wall sections.

### BRIEF SUMMARY

According to various example embodiments of the present general inventive concept, an in-wall pool ladder is provided to be included in a pool wall, the ladder being formed so as to receive a liner over the ladder without openings being made in the liner.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing an in-wall ladder to be installed in a swimming pool, the ladder including a frame portion configured with a substantially flat front surface and a central opening, a plurality of step portions configured to extend back from the front surface of the frame portion, in a substantially parallel arrangement in the central opening, and a plurality of riser portions configured to extend back in the central opening at an angle from the front surface of the frame portion to a point proximate a back edge of each respective step portion located below each respective riser portion.

The foregoing and/or other aspects and advantages of the present general inventive concept may be achieved by providing an in-wall ladder module to be installed in a swimming pool, the ladder including a frame portion configured with two outer side edges, an outer top edge, an outer bottom edge, two inner side edges, an inner top edge, and an inner bottom edge, a plurality of step portions configured to extend back from the inner side edges of the frame portion, in a substantially parallel arrangement, a plurality of riser portions configured to extend up at an angle from a back edge of each of the step portions to the inner side edges of the frame portion, and having a lip extends down behind the back edge of the step portion below each respective riser, lateral support members extending back from each of the respective inner side edges of the frame portion, the lateral support members being configured to be adjacent to side edges of the step portions and riser portions, and riser support flanges extending back from the respective side edges of the riser portions and configured to be attachable to the lateral support members adjacent the corresponding outer edges of the riser portions, wherein the back edge of the step portions and the lips of the adjacent riser portions are configured to secure a portion of a pool liner therebetween.

The foregoing and/or other aspects and advantages of the present general inventive concept may also be achieved by providing a method of forming an in-wall ladder module to be installed in a swimming pool, the method including forming, from a continuous piece of metal, a frame portion configured with two outer side edges, an outer top edge, an outer bottom edge, two inner side edges, an inner top edge, an inner bottom edge, and lateral support members extending back from each of the respective inner side edges, forming a plurality of step members having a step portion, a riser portion extending down at an angle from a front edge of the step portion, a riser flange extending downward from a rear edge of the riser portion, a step flange extending downward from a rear edge of the step portion, and riser support flanges extending back from respective side edges of the riser portions, the respective step members each being formed from a continuous piece of metal, attaching the step members between the lateral support members of the frame portion such that the riser support flanges are secured to the respective lateral support members, and the riser flange of each riser portion is secured to the step flange of the step member below the corresponding riser portion such that a portion of a pool liner can be tucked between the corresponding riser and step flanges to hold the pool liner in place on the ladder.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a front perspective view of an in-wall pool ladder according to an example embodiment of the present general inventive concept;

FIG. 2 illustrates a back perspective view of the in-wall pool ladder of FIG. 2;

FIGS. 3A-B illustrates a cross section of a portion of the in-wall pool ladder of FIGS. 1-2, before and after the installation of a pool liner on the ladder; and

FIG. 4 is a flow chart illustrating a method of forming an in-wall ladder according to an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, an in-wall swimming pool ladder is provided that may be produced in a number of configurations and installed behind the liner of the swimming pool. This allows the liner to be a one-piece covering over the ladder, as opposed to requiring a faceplate and gaskets at the interface between the ladder and vinyl liner of the pool. The overall configuration of the ladder, including the steps, can be formed in a number of desired arrangements, and the vinyl liner can be thermoformed to fit the contours of the steps. Various example embodiments of the present general inventive concept may also utilize pool liner track arrangements to hold the liner captive in portions of the steps, such as the rear of the treads. Various example embodiments of the present general inventive concept may provide a ladder or ladder assembly made of galvanized steel, which allows different widths and tread configurations of the ladder to be easily produced. In various descriptions herein the in-wall pool ladder may be referred to simply as a pool ladder or ladder, or as a ladder module, as it can be used with other modular pool wall sections.

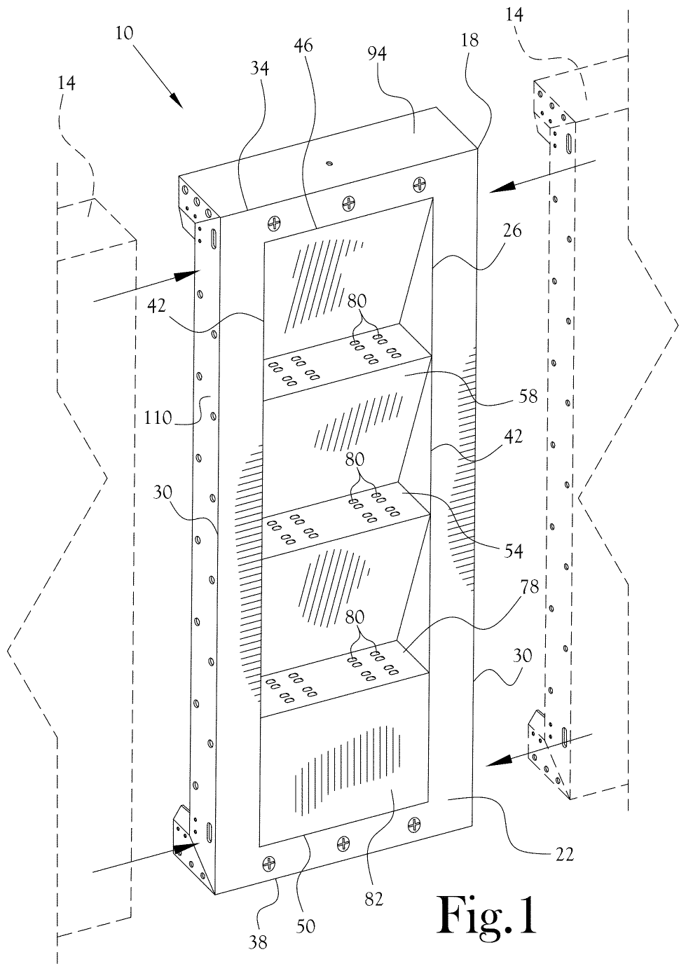

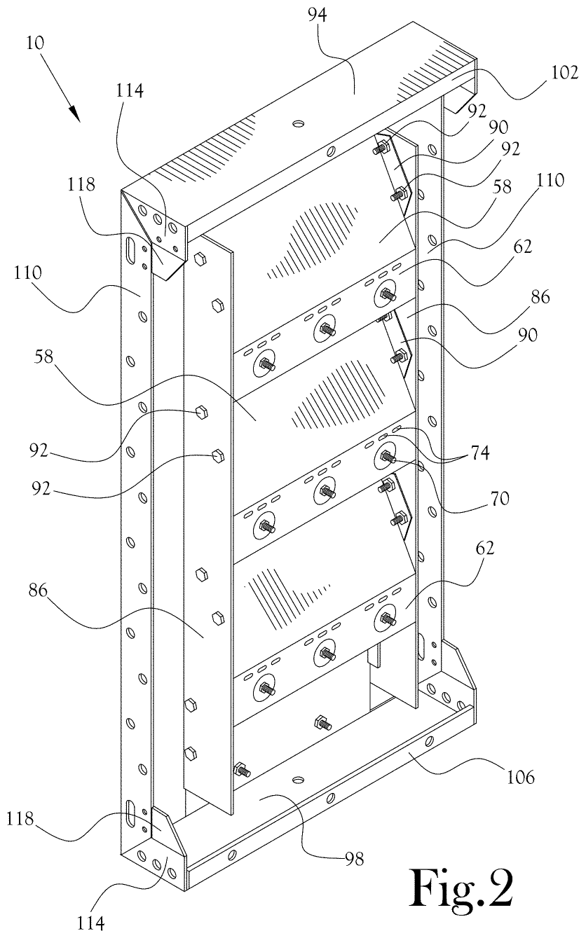

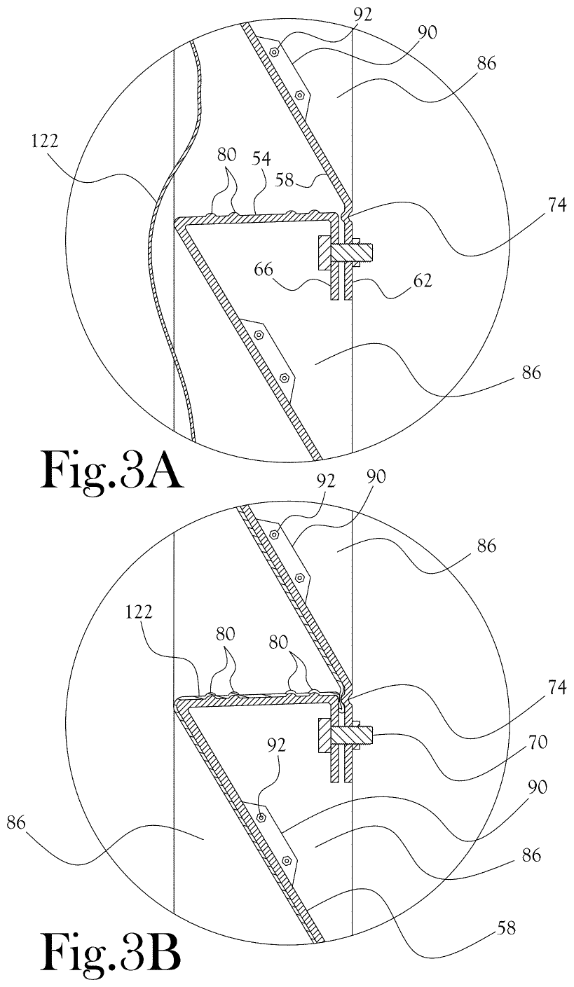

FIG. 1 illustrates a front perspective view of an in-wall pool ladder according to an example embodiment of the present general inventive concept, and FIG. 2 illustrates a back perspective view of the in-wall pool ladder of FIG. 2. In this example embodiment, the in-wall pool ladder 10 is provided so as to be connectable to other modular pool wall sections 14 as shown in FIG. 1. The ladder 10 of this example embodiment is built with a frame portion 18 having a substantially flat front surface 22 surrounding a central opening 26 in which the steps of the ladder 10 are arranged. The front surface 22 of the frame portion 18 is defined by two outer side edges 30, an outer top edge 34, and an outer bottom edge 38, with two inner side edges 42, an inner top edge 46, and an inner bottom edge 50 bordering the central opening 26. It is understood that various different configurations may be employed without departing from the scope of the present general inventive concept. As illustrated in FIGS. 1-2, the ladder 10 is formed with a plurality of step portions 54 with corresponding riser portions 58 placed therebetween. The step portions 54 are planar and arranged so as to be slightly angled, extending back and up from the front surface 22, or from the inner side edges 42, of the frame portion 18. The step portions 54 are arranged at the slight angle downward toward the front surface 22 to facilitate the drainage of pool water off of the steps that are not submerged, and to make it easier for a user to climb out of the pool. As illustrated in FIG. 1, a plurality of raised protrusions 80 may be formed in the step portions 54 to provide grip and decrease the likelihood of a user's foot slipping on the step portion 54 surface. Although four rows and columns of the raised protrusions 80 are shown in this example embodiment, it is understood that different numbers, configurations, shapes, etc., may be provided without departing from the scope of the present general inventive concept. The riser portions 58 are arranged so as to extend back from the front surface 22 at an angle to a back edge of a step portion 54 immediately underneath the riser portion 58, such that one of the respective riser portions 58 extend forward and up from a back edge of each of the step portions 54. In this example embodiment, each of the frame portion 18, step portions 54, and riser portions 58 may be formed of galvanized steel. In various example embodiments at least some of the riser portions 58 may be formed continuously with the corresponding step portions 58 located immediately above those riser portions 58. At the back edge of each of the riser portions 58, a riser flange 62 extends downward behind the back edges of the step portions 54, and is configured to face a corresponding step flange 66 that extends downward from the back edges of each of the step portions 54. This arrangement is illustrated more clearly in FIGS. 3A-3B, which will be discussed herein. The riser flanges 62 and step flanges 66 are configured so as to be secured to one another to provide structure for the ladder assembly. In various example embodiments, each of the respective riser flanges 62 are connected to a corresponding step flange 66 by one or more securing members 70, which in this example are a plurality of bolt and nut assemblies passing through corresponding through holes in the step flanges 66 and riser flanges 62. In various example embodiments the step flanges 66 and riser flanges 62 may be adhered to each other by adhesive, or welding, etc.

A plurality of detents 74 are formed proximate an upper edge of the riser flanges 62, and are configured to extend in the direction of the corresponding step flanges 66. The step flanges 66 and riser flanges 62 are configured to hole a portion of a pool liner therebetween, and the detents 74 assist by “pinching” contacted portions of the pool liner to the back of the step flanges 66. FIGS. 3A-B illustrates a cross section of a portion of the in-wall pool ladder of FIGS. 1-2, before and after the installation of a pool liner 122 on the ladder 10. As illustrated in FIG. 3A, the ladder assembly can be put together and installed in a pool wall, and then, as illustrated in FIG. 3B, the pool liner 122 can be applied to the ladder 10 by tucking portions of the pool liner 122 in between the facing riser flanges 62 and step flanges 66. In this example embodiment, the detents 74 help to secure the contacted section of the pool liner 122 in place, but various other example embodiments may omit these detents 72, and/or may provide other fixing members to one or both of the riser flanges 62 and step flanges 66. Tightening of the securing members 70 that connect the riser flanges 62 to the step flanges 66 may provide more pressure to hold the pool liner 122 in place. In various example embodiments the vinyl is formed with a lip at a space corresponding to the detents 74, and the lip in the vinyl interacts with the detents 74 to secure the vinyl liner 122 in place over the ladder 10 in the form of the ladder 10. In various example embodiments the vinyl lip is formed with an extending portion that bends toward the liner when passing by the detents 74, and then “snaps” into place under the detents 74 to secure the liner 122 in place. In various example embodiments, the pool liner 122 forms with a fit over plurality of raised protrusions 80 formed in the step portions 54 to provide grip and decrease the likelihood of a user's foot slipping on the step portion 54 surface, and in other example embodiments the pool liner 122 may have receiving portions formed in the liner to correspond to the raised protrusions 80. With the pool liner 122 securely in place and conforming to the shape of the ladder module 10, an aesthetically pleasing look is produced with the pool ladder, without the problems with tears, leaks, etc., discussed regarding the conventional ladder assemblies.

Looking back to FIGS. 1-2, in this example embodiment a bottom stop portion 78 is formed with a flat riser portion 82 beneath. This flat riser portion 82 is formed to be substantially flush with the front surface 22 of the frame portion 18, and fills much of the corresponding portion central opening 26 in which it is arranged. The bottom of flat riser portion 82 is secured to the frame portion 18 proximate a bottom thereof with countersunk threaded members, so that that part of the frame portion 18 and the flat riser portion 82 are all substantially flat so as to not make any part of the pool liner 122 protrude. Similarly, the top riser portion 58 has a lip (not illustrated) that is secured to the frame portion 18 proximate a top thereof with countersunk threaded members. The step assemblies between the top riser and the bottom step portion 78 may be formed such that the step portion 54, riser portion 58, riser flange 62, and step flange 66 are all formed continuously with a single piece of metal, which results in easier and more convenient fabrication.

As illustrated in FIG. 2, a pair of lateral support members 86 are arranged to respectively extend back from the inner side edges 42 of the frame portion 18 so as to be adjacent to the respective side edges of the step portions 54 and riser portions 58. These lateral support members 86 can be adhered or otherwise connected to the sides of the step portions 54 and/or riser portions 58 to provide structural support for the ladder assembly. In this example embodiment, riser support flanges 90 are provided on the side edges of each of the riser portions 58, and are configured to be connected to the respective adjacent lateral support members 86. In this example embodiment, each of the riser support flanges 90 has through holes that correspond to through holes formed in the lateral support members 86, and nut and bolt assemblies 92 are used in the through holes to secure the riser support flanges 90 to the lateral support members 86. In various example embodiments the riser support flanges 90 are formed to be continuous with the corresponding riser portions 58.

The ladder 10 of this example embodiment includes a top surface member 94 that extends back from the outer top edge 34 of the frame portion 18, and a bottom surface member 98 that extends back from the outer bottom edge 38 of the frame portion 18. These top and bottom surface members 94,98 may be formed continuously with the frame portion 18 in various example embodiments of the present general inventive concept. An upper flange 102 extends downward from a back edge of the top surface member 94, and a lower flange 106 extends upward from a back edge of the bottom surface member 98. The upper flange 102 and lower flange 106 are configured so as to be connectable to respective joining members, such as support band members that run behind similar flanges in a plurality of connected pool wall modules, so that the ladder module 10 can be further secured to neighboring portions of the pool wall. Similarly, side surface members 110 extend back from each respective outer side edge 30 of the frame portion 18 to provide contact surfaces to similar contact surfaces of neighboring pool wall modules. A variety of through holes may be provided in the side surface members 110 to receive securing members, such as threaded bolts and nuts, to secure the modules to one another. In this example embodiment, additional side surface members 114 are also formed so as to extend downward from the side edges of the top surface member 94, and upward from the side edges of the bottom surface member 98. These additional side surface members 114 provide more of a connecting surface to neighboring pool wall modules, and may be connected to the side surface member 110 by braces 118 secured to adjacent ones of the side surface members 110 and additional side surface members 114. In various example embodiments, the frame portion 18, lateral support members 86, top surface member 94, bottom surface member 98, side surface members 110, and additional side surface members 114 may be formed so as to be continuous from one piece of metal, which simplifies the fabrication process. As such an assembly can be constructed of galvanized steel, stainless steel, or aluminum, it can be easily configured to any shape and size desired by the pool owner or manufacturer. Example embodiments of the present general inventive concept can provide a ladder that can be produced in any configuration without dedicated tooling, and also allows a pool liner to be in one piece covering the ladder as opposed to requiring faceplates, gaskets, etc., at the interface between the ladder and vinyl liner of the pool. Various example embodiments may utilize a liner track to make the liner captive in the rear of the treads. Various example embodiments may utilize thermoformed vinyl to fit the steps of the ladder. The ladder of the present general inventive concept can be easily produced in a number of different widths and tread configurations without dedicated tooling.

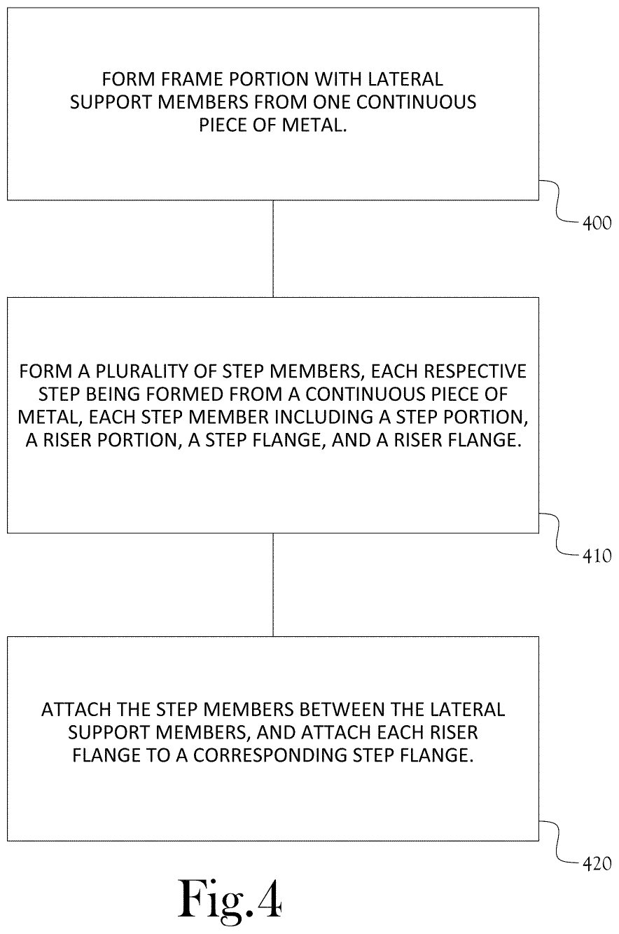

FIG. 4 is a flow chart illustrating a method of forming an in-wall ladder according to an example embodiment of the present general inventive concept. In operation 400 a frame portion is fabricated from a continuous piece of metal, the frame portion having two outer side edges, an outer top edge, an outer bottom edge, two inner side edges, an inner top edge, an inner bottom edge, and lateral support members extending back from each of the respective inner side edges. In operation 410 a plurality of step members are formed, each stop member having a step portion, a riser portion extending down at an angle from a front edge of the step portion, a riser flange extending downward from a rear edge of the riser portion, a step flange extending downward from a rear edge of the step portion, and riser support flanges extending back from respective side edges of the riser portions, the respective step members each being formed from a continuous piece of metal. In operation 420 the step members are attached between the lateral support members of the frame portion such that the riser support flanges are secured to the respective lateral support members, and the riser flange of each riser portion is secured to the step flange of the step member below the corresponding riser portion such that a portion of a pool liner can be tucked between the corresponding riser and step flanges to hold the pool liner in place on the ladder. It is understood that various example embodiments of the present general inventive concept may provide more, fewer, and/or different operations without departing from the scope of the present general inventive concept.

Various example embodiments of the present general inventive concept may provide an in-wall ladder to be installed in a swimming pool, the ladder including a frame portion configured with a substantially flat front surface and a central opening, a plurality of step portions configured to extend back from the front surface of the frame portion, in a substantially parallel arrangement in the central opening, and a plurality of riser portions configured to extend back in the central opening at an angle from the front surface of the frame portion to a point proximate a back edge of each respective step portion located below each respective riser portion. The frame portion, step portions, and riser portions may be formed of galvanized steel. The ladder of claim 1, wherein at least one of the riser portions is formed continuously with a step portion immediately above the at least one of the riser portions. The ladder may further include a riser flange extending downward from a rear of each of the riser portions and behind a rear edge of a corresponding step portion below the respective riser portions, and a step flange extending downward from the rear edge of each of the step portions, and configured to face the riser flange of a corresponding riser portion immediately above the respective step portions. Each facing pair of riser and step flanges may be configured to secure a pool liner therebetween and in place over the ladder. Each of the respective facing pairs of riser and step flanges may be configured to be secured to one another. Each of the respective facing pairs of riser and step flanges may be secured to one another by one or more threaded bolt and nut assemblies. The ladder may further include a plurality of detents formed in each of the riser flanges, configured to protrude forward toward a corresponding step flange so as to secure a pool liner in place over the ladder. The detents may be biased toward the corresponding step flange to secure the pool liner such that the pool liner conforms to the shape of the step and riser portions. A bottom step portion may be configured with a flat riser portion that is secured to a bottom portion of the frame portion so as to be substantially co planar with the front surface. The flat riser portion of the bottom step portion may fill a part of the central opening of the frame portion. A top riser portion may be configured with an upper lip that is secured to a top portion of the frame portion. The front surface of the frame portion may be defined by two outer side edges, an outer top edge, an outer bottom edge, two inner side edges, an inner top edge, and an inner bottom edge. The ladder may further include lateral support members extending back from each of the respective inner side edges, the lateral support members being configured to be adjacent to side edges of the step portions and riser portions. The ladder may further include riser support flanges extending back from the respective side edges of the riser portions and configured to be attachable to the lateral support members adjacent the corresponding outer edges of the riser portions. The ladder may further include a top surface member extending back from the outer top edge of the frame portion, and a bottom surface member extending back from the outer bottom edge of the frame portion, wherein the top surface member and the bottom surface member may be formed continuously with the frame portion. The ladder may further include an upper flange extending downward from a back edge of the top surface member, and a lower flange extending upward from a back edge of the bottom surface member, wherein the upper flange and lower flange may be configured to be connectable to support band members that extend to connect to pool wall modules on either side of the ladder. The ladder may further include side surface members extending back from each outer side edge of the frame portion, wherein the side surface members may be configured to be connected side surface members of pool wall modules on either side of the ladder. At least a portion of a pool liner may be thermoformed over the ladder to fit the contours of the step portions and riser portions.

Various example embodiments of the present general inventive concept may provide an in-wall ladder module to be installed in a swimming pool, the ladder including a frame portion configured with two outer side edges, an outer top edge, an outer bottom edge, two inner side edges, an inner top edge, and an inner bottom edge, a plurality of step portions configured to extend back from the inner side edges of the frame portion, in a substantially parallel arrangement, a plurality of riser portions configured to extend up at an angle from a back edge of each of the step portions to the inner side edges of the frame portion, and having a lip extends down behind the back edge of the step portion below each respective riser, lateral support members extending back from each of the respective inner side edges of the frame portion, the lateral support members being configured to be adjacent to side edges of the step portions and riser portions, and riser support flanges extending back from the respective side edges of the riser portions and configured to be attachable to the lateral support members adjacent the corresponding outer edges of the riser portions, wherein the back edge of the step portions and the lips of the adjacent riser portions are configured to secure a portion of a pool liner therebetween.

Various example embodiments of the present general inventive concept may provide a method of forming an in-wall ladder module to be installed in a swimming pool, the method including forming, from a continuous piece of metal, a frame portion configured with two outer side edges, an outer top edge, an outer bottom edge, two inner side edges, an inner top edge, an inner bottom edge, and lateral support members extending back from each of the respective inner side edges, forming a plurality of step members having a step portion, a riser portion extending down at an angle from a front edge of the step portion, a riser flange extending downward from a rear edge of the riser portion, a step flange extending downward from a rear edge of the step portion, and riser support flanges extending back from respective side edges of the riser portions, the respective step members each being formed from a continuous piece of metal, attaching the step members between the lateral support members of the frame portion such that the riser support flanges are secured to the respective lateral support members, and the riser flange of each riser portion is secured to the step flange of the step member below the corresponding riser portion such that a portion of a pool liner can be tucked between the corresponding riser and step flanges to hold the pool liner in place on the ladder.

Various example embodiments of the present general inventive concept may provide an in-wall ladder to be installed in a swimming pool, the ladder including a frame portion configured with a substantially flat front surface and a central opening, a plurality of step portions configured to extend back from the front surface of the frame portion, in a substantially parallel arrangement in the central opening, and a plurality of angled riser portions configured to extend back from the front surface of the frame portion to a point proximate a back edge of each respective step portion located below each respective angled riser portion. The frame portion, step portions, and angled riser portions may include galvanized steel. At least one of the angled riser portions may be formed continuously with a step portion immediately above the at least one of the angled riser portions. The ladder may further include a downward extending portion extending downward from a rear of each of the angled riser portions and behind a rear edge of the corresponding step portion below the respective angled riser portions, and a plurality of detents formed in each of the downward extending portions, configured to protrude forward so as to secure a pool liner in place over the ladder.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. An in-wall ladder to be installed in a swimming pool, the ladder comprising:
a frame portion configured with a substantially flat front surface and a central opening;
a plurality of step portions configured to extend back from the front surface of the frame portion, in a substantially parallel arrangement in the central opening; and
a plurality of riser portions configured to extend back in the central opening at an angle from the front surface of the frame portion to a point proximate a back edge of each respective step portion located below each respective riser portion.

2. The ladder of claim 1, wherein the frame portion, step portions, and riser portions comprise galvanized steel.

3. The ladder of claim 1, wherein at least one of the riser portions is formed continuously with a step portion immediately above the at least one of the riser portions.

4. The ladder of claim 1, further comprising:
a riser flange extending downward from a rear of each of the riser portions and behind a rear edge of a corresponding step portion below the respective riser portions; and
a step flange extending downward from the rear edge of each of the step portions, and configured to face the riser flange of a corresponding riser portion immediately above the respective step portions.

5. The ladder of claim 4, wherein each facing pair of riser and step flanges are configured to secure a pool liner therebetween and in place over the ladder.

6. The ladder of claim 5, wherein each of the respective facing pairs of riser and step flanges are configured to be secured to one another.

7. The ladder of claim 6, wherein each of the respective facing pairs of riser and step flanges are configured to be secured to one another by one or more threaded bolt and nut assemblies.

8. The ladder of claim 4, further comprising a plurality of detents formed in each of the riser flanges, configured to protrude forward toward a corresponding step flange so as to secure a pool liner in place over the ladder.

9. The ladder of claim 8, wherein the detents are configured to be biased toward the corresponding step flange to secure the pool liner such that the pool liner conforms to the shape of the step and riser portions.

10. The ladder of claim 1, wherein a bottom step portion is configured with a flat riser portion that is secured to a bottom portion of the frame portion so as to be substantially co planar with the front surface.

11. The ladder of claim 10, wherein the flat riser portion of the bottom step portion is configured to fill a part of the central opening of the frame portion.

12. The ladder of claim 1, wherein a top riser portion includes an upper lip configured to be secured to a top portion of the frame portion.

13. The ladder of claim 1, wherein the front surface of the frame portion is defined by two outer side edges, an outer top edge, an outer bottom edge, two inner side edges, an inner top edge, and an inner bottom edge.

14. The ladder of claim 13, further comprising lateral support members extending back from each of the respective inner side edges, the lateral support members being configured to be adjacent to side edges of the step portions and riser portions.

15. The ladder of claim 14, further comprising riser support flanges extending back from the respective side edges of the riser portions and configured to be attachable to the lateral support members adjacent the corresponding outer edges of the riser portions.

16. The ladder of claim 13, further comprising:
a top surface member extending back from the outer top edge of the frame portion; and
a bottom surface member extending back from the outer bottom edge of the frame portion;
wherein the top surface member and the bottom surface member are formed continuously with the frame portion.

17. The ladder of claim 16, further comprising:
an upper flange extending downward from a back edge of the top surface member; and
a lower flange extending upward from a back edge of the bottom surface member;
wherein the upper flange and lower flange are configured to be connectable to support band members that extend to connect to pool wall modules on either side of the ladder.

18. The ladder of claim 13, further comprising:
side surface members extending back from each outer side edge of the frame portion;
wherein the side surface members are configured to be connected side surface members of pool wall modules on either side of the ladder.

19. The ladder of claim 1, wherein a pool liner is thermoformed over the ladder to fit the contours of the step portions and riser portions.

20. An in-wall ladder module to be installed in a swimming pool, the ladder comprising:
a frame portion configured with two outer side edges, an outer top edge, an outer bottom edge, two inner side edges, an inner top edge, and an inner bottom edge;
a plurality of step portions configured to extend back from the inner side edges of the frame portion, in a substantially parallel arrangement;
a plurality of riser portions configured to extend up at an angle from a back edge of each of the step portions to the inner side edges of the frame portion, and having a lip extends down behind the back edge of the step portion below each respective riser;
lateral support members extending back from each of the respective inner side edges of the frame portion, the lateral support members being configured to be adjacent to side edges of the step portions and riser portions; and
riser support flanges extending back from the respective side edges of the riser portions and configured to be attachable to the lateral support members adjacent the corresponding outer edges of the riser portions;
wherein the back edge of the step portions and the lips of the adjacent riser portions are configured to secure a portion of a pool liner therebetween.

21. A method of forming an in-wall ladder module to be installed in a swimming pool, the method comprising:
forming, from a continuous piece of metal, a frame portion configured with two outer side edges, an outer top edge, an outer bottom edge, two inner side edges, an inner top edge, an inner bottom edge, and lateral support members extending back from each of the respective inner side edges;
forming a plurality of step members having a step portion, a riser portion extending down at an angle from a front edge of the step portion, a riser flange extending downward from a rear edge of the riser portion, a step flange extending downward from a rear edge of the step portion, and riser support flanges extending back from respective side edges of the riser portions, the respective step members each being formed from a continuous piece of metal;
attaching the step members between the lateral support members of the frame portion such that the riser support flanges are secured to the respective lateral support members, and the riser flange of each riser portion is secured to the step flange of the step member below the corresponding riser portion such that a portion of a pool liner can be tucked between the corresponding riser and step flanges to hold the pool liner in place on the ladder.
